(19) United States
(12) Patent Application Publication
(10) Pub. No.: US 2006/0214034 A1
(43) Pub. Date: Sep. 28, 2006

(54) Attachment for air spray gun

(76) Inventors: Shingo Kurosaka, Yokohama (JP); Kunihisa Tomita, Yokohama (JP)

Correspondence Address: WENDEROTH, LIND & PONACK, L.L.P., 2033 K STREET N. W., SUITE 800, WASHINGTON, DC, 20006-1021, US

(21) Appl. No.: 11/378,240

(22) Filed: Mar. 20, 2006

(30) Foreign Application Priority Data
Mar. 24, 2005 (JP) 2005-85906

(51) Int. Cl. B05B 15/08

(52) U.S. Cl. 239/587.2

(57) ABSTRACT

There is provided an attachment for an air spray gun, to be connected to the bottom of a grip of the spray gun. It includes a control valve to adjust the air flow rate, a gun coupling disposed in the body of the control valve to communicate with an outlet-side passage and thus connect to the spray gun, and a rotary joint having a hose coupling fixed thereto and which is to be fitted rotatably into an inlet-side passage to allow the hose coupling to communicate with the inlet-side passage. The hose coupling is freely turned in relation to the gun coupling fixed to the spray gun for the angle formed between them to freely be variable. A pressure gauge is installed to the attachment to communicate with the outlet-side passage and indicate the pressure of air supplied through the passage. The display surface of the pressure gauge forms an obtuse angle in relation to the axis of the gun coupling.

### BACKGROUND OF THE INVENTION

1. Field of the Invention

The present invention generally relates to an air spray gun that atomizes a paint or the like under the action of pressurized air and sprays the resultant paint mist to an object which is to be coated with the paint, and more particularly, to an attachment which is to be connected to an air inlet of the air spray gun to adjust and check the pressure of air introduced through the air inlet into the spray gun.

2. Description of the Related Art

The air spray gun is used to atomize a paint under the action of pressurized air and spray the paint mist produced as above. Therefore, the quality of a paint coating thus formed depends upon the condition of such pressurized air. Normally, the worker using the spray gun checks the air pressure at the time of spraying a paint. In case it is necessary to change the spraying conditions correspondingly to a surface variation of an object to be coated and use of another paint, the worker has to adjust pressurized air for supply to the air spray gun by operating a pressure reducing valve or the like provided in the middle of a supply passage from an air source until an air pressure required for the spraying is attained. Also, for continuously assuring a stable quality of the coating, it is necessary to keep a constant air pressure and check the air pressure during spraying as well.

Normally, the air spray gun is supplied with pressurized air whose pressure has been adjusted at an air compressor or the like located away from the spray gun. Therefore, many of the air spray guns have no air pressure control provided on themselves. When changing the air pressure or adjusting it to a correct level, the worker has to leave the working site and go to the air compressor located away from the site to adjust a regulating valve of the compressor. Thus, the worker has to interrupt the coating work at each time of the adjustment. To solve the above problem, there have been proposed some air spray guns provided with a valve to adjust the air flow rate instead of adjusting the spraying pressure. With such a valve, the worker can adjust the spraying pressure but cannot still check the spraying pressure. In effect, the worker has to address the air pressure adjustment intuitively by experience.

Improvement in appearance, by the finish coating, of products of commerce is very important for raising the added value of the products as well as for economic use of an expensive paint having been used to meet the recent need for a higher quality. One of the basic coating techniques for the quality coating is to assure a correct spraying pressure. To solve the scattering of paint mist as a basic problem of the air spray gun, it has been required to improve the efficiency of paint adhesion for higher friendliness to the worker and environment. One of the possible solutions is to reduce the spraying pressure. The reduced spraying pressure has been proved to be practically effective for less scattering of the paint mist. The reduction of air pressure is legally required in some cases in which it will be required that the spraying pressure can be checked.

A spray gun incorporating a pressure gauge will be a solution to the above problem, but it will be expensive. Generally, however, a joint having a pressure gauge is connected to the air inlet of the spray gun when it is necessary to check the spraying pressure.

### SUMMARY OF THE INVENTION

Most of air spray guns of a hand-held type are designed for use with an air hose being connected at one end thereof to the bottom of a grip and at the other end to a pressurized air source. The spray gun of this type will be operable with a highest stability because it is not influenced by the connected air hose. However, the air hose connected to the grip, extending to below the worker's hand holding the spray gun, will interfere with the spraying work as the case may be even if it is flexible. For example, an obstacle, if any, below the spray gun held by the worker will be in touch with the air hose extending downward, which will make it difficult to operate the spray gun accurately. In this respect, the aforementioned coupling with a pressure gauge will be more disadvantageous for spray coating with the spray gun.

It is therefore preferable to overcome the above-mentioned drawbacks of the related art by providing an attachment for a spray gun, usable with the latter with less limitation, by an air hose, of operationality and moving range of the spray gun and permitting easy checking of the spraying pressure.

According to the present invention, there is provided an air spray gun attachment which is to be connected to the bottom of a grip of the spray gun and to which a compressed air supply hose is to be connected, the attachment including:
a control valve disposed in the middle of an air passage through the attachment to adjust the rate of air flow through the air passage;
a gun coupling disposed on the outer surface of the control valve to communicate with the passage at the outlet side and which is to be connected to the spray gun; and
a rotary joint having a hose coupling to which an air hose is to be connected and which is to be fitted rotatably into the inlet-side passage to allow the hose coupling to communicate with the inlet-side passage,
the angle formed between axes of the gun coupling and hose coupling being freely variable.

Thus, the extending direction of the air hose connected to the attachment can freely be changed horizontally and vertically.

Also, a pressure gauge is installed to the attachment to communicate with the outlet-side passage and indicates the pressure of air supplied through the passage. The pressure gauge is installed for a display surface thereof to form an obtuse angle in relation to the axis of the gun coupling, whereby the worker holding and operating the spray gun in a normal spray coating can easily view the display surface of the pressure gauge to check an air pressure.

With the attachment according to the present invention being installed to a spray gun, it is possible to easily check the pressure of air supplied to the spray gun. When the supplied air pressure has been varied and is to be adjusted, it can be fine-adjusted using the control valve and the adjusted air pressure can accurately be checked. Thereby, it is possible to address a surface variation of an object to be coated and thus assure a quality coating and also minimize variation of coating quality, possibly caused by shift from one to another worker, interruption of the coating work or the like.

An obstacle, if any, existing below the spray gun being in use will not be in touch with the air hose when the latter is moved laterally as indicated with a dotted line in FIG. 3, whereby the spray gun can be operated with a minimum limitation of its operationality and moving range.

The foregoing and other features, aspects and advantages of the present invention will be come apparent from the following detailed description of the present invention when taken in conjunction with the accompanying drawings.

### BRIEF DESCRIPTION OF THE DRAWINGS

FIG. 1 is a sectional view of the attachment as one embodiment of the present invention, showing the entire structure;

FIG. 2 is a lateral view, from the left, of the attachment in FIG. 1; and

FIG. 3 shows a spray gun having the attachment in FIG. 1 connected thereto.

### DETAILED DESCRIPTION OF THE PREFERRED EMBODIMENTS

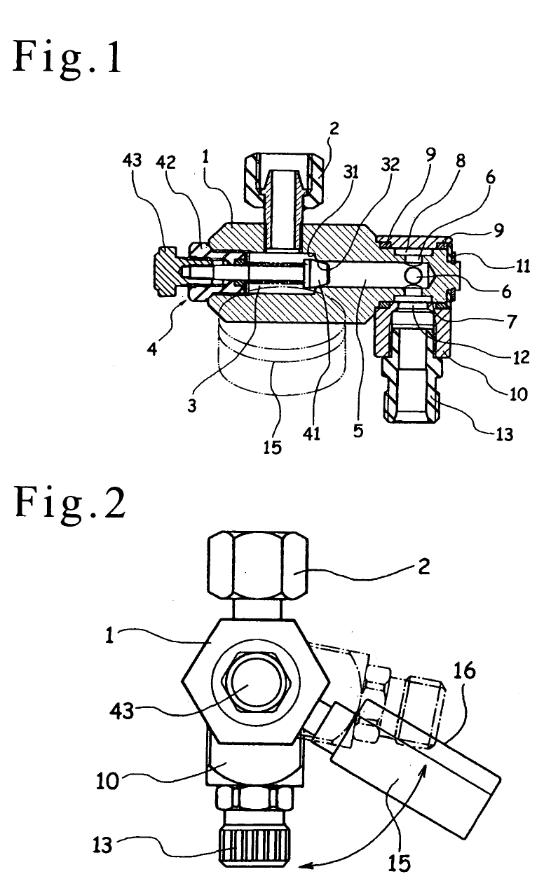

FIG. 1 shows the entire structure of the air spray gun attachment as an embodiment of the present invention. As shown, the attachment includes a body 1 having a gun coupling 2 provided at the lateral side thereof for connection to the spray gun, and an air passage 3 formed axially at one end thereof to communicate with the gun coupling 2. The air passage 3 is stepped at an inner end 31 thereof to form a valve seat 32, and has a control valve 4 assembled to an opening-side end thereof to adjust the opening of the passage by moving a valve body 41 back and forth so that the flow rate of air flowing through the passage 3. The valve body 41 of the control valve 4 moving together with a knob 43 screwed in a guide 42 is moved back and forth as the knob 43 is rotated. The control valve 4 has a well-known structure but it may have any other structure included in the conventional art.

The valve seat 32 has an inlet-side passage 5 open at the small-diameter thereof. The inlet-side passage 5 is open at a communication hole 6 leading to the outer surface at the other end of the body 1. The communication hole 6 is formed at four places in the illustrated embodiment. It is formed as a cylindrical hole at an opening lateral portion 7 of the body 1, and as a recess 8 at the outer surface of the body 1. A gasket 9 is provided in the recess 8 to prevent air leakage, and a rotary joint 10 is fitted on the lateral portion 7. The rotary joint 10 is freely rotatable in relation to the cylindrical lateral portion 7, and a snap ring 11 is used to prevent the rotary joint 10 from being disengaged from the lateral portion 7. The rotary joint 10 has formed at one side thereof an inlet 12 leading to the recess 8 and to a hose coupling 13 to which an air hose extending from the air source is to be connected. Since the rotary joint 10 is rotatable in relation to the body 1 for use in a desired position, the recess 8 and communication hole 6 are large enough not to vary in size when the rotary joint 10 is rotated.

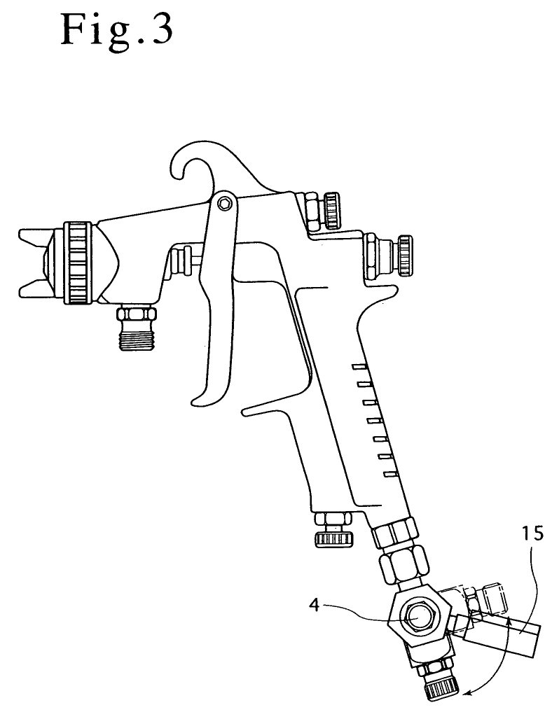

FIG. 3 shows the attachment installed to the spray gun. FIGS. 1 and 2 show the gun coupling connected to the grip of the spray gun and the hose coupling, the couplings being pointed in parallel directions as indicated with solid lines. With the hose coupling being in such a position, however, the air hose will extend straightly downward and any correct pointing of the spray nozzle is difficult depending upon the situation of the object. For example, in case an object portion is near the floor, the spraying cannot correctly be done. In this case, the hose coupling is to be turned laterally as indicated with a chained line in FIG. 3. Also, the spray gun can be placed upright while it is not being used during interruption of the spraying work.

FIG. 2 is a lateral view, from the left, of the attachment in FIG. 1. As shown, a pressure gauge 15 with a display surface 16 is installed to the attachment which is to be connected to the air passage 3. According to this embodiment, the display surface 16 of the pressure gauge 15 is tilted about 120 deg. in relation to the axis of the gun coupling 2. The pressure gauge 15 is of an analog bourdon tube type, but the present invention is not limited in structure and size to this pressure gauge 15. However, easiness to view should be taken in account in selecting a pressure gauge for use with the present invention.

As above, the spray gun is normally supplied with an air pressure having been adjusted by a pressure reducing valve or the like provided separately. However, the actual air pressure finally supplied to the spray gun should be checked in many cases. In such cases, the pressure gauge installed to the attachment according to the present invention permits easy checking of the air pressure at the spray gun itself. When the air pressure has to be fine-adjusted, the control valve included in the attachment permits immediate adjustment of the air pressure. The worker holding the spray gun will normally take somewhat downward look at the pressure gauge of the attachment installed to the bottom of the spray gun. The obtuse positioning of the display surface 16 will permit easy viewing.

In the foregoing, the present invention has been described in detail concerning certain preferred embodiments thereof as examples with reference to the accompanying drawings. However, it should be understood by those ordinarily skilled in the art that the present invention is not limited to the embodiments but can be modified in various manners, constructed alternatively or embodied in various other forms without departing from the scope and spirit thereof as set forth and defined in the appended claims.

What is claimed is:

1. An attachment for an air spray gun, which is to be connected to the bottom of a grip of the spray gun and to which a compressed air supply hose is to be connected, the attachment comprising:
a control valve disposed in the middle of an air passage through the attachment to adjust the rate of air flow through the air passage;
a gun coupling disposed on the outer surface of the control valve to communicate with the passage at the outlet side and which is to be connected to the spray gun; and
a rotary joint having a hose coupling to which an air hose is to be connected and which is to be fitted rotatably into the inlet-side passage to allow the hose coupling to communicate with the inlet-side passage,
the angle formed between axes of the gun coupling and hose coupling being freely variable.

2. The attachment according to claim 1, further comprising a pressure gauge installed to the attachment to communicate with the outlet-side passage,
the display surface of the pressure gauge forming an obtuse angle in relation to the axis of the gun coupling.
